(19) United States
(12) Patent Application Publication
(10) Pub. No.: US 2019/0258604 A1
(43) Pub. Date: Aug. 22, 2019

(54) SYSTEM AND METHOD FOR IMPLEMENTING A QUOTA SYSTEM IN A DISTRIBUTED FILE SYSTEM

(71) Applicant: NetApp, Inc., Sunnyvale, CA (US)

(72) Inventors: Michael Eisler, Colorado Springs, CO (US); Robert Wyckoff Hyer, JR., Seven Fields, PA (US); Daniel Tennant, Pittsburgh, PA (US); Richard P. Jernigan, IV, Sewickley, PA (US)

(21) Appl. No.: 16/405,034

(22) Filed: May 7, 2019

Related U.S. Application Data
(63) Continuation of application No. 14/317,791, filed on Jun. 27, 2014.

(51) Int. Cl. G06F 16/11; G06F 16/13; G06F 16/182

(52) U.S. Cl. CPC G06F 16/11; G06F 16/1827; G06F 16/13

(57) ABSTRACT

A system and method for implementing a quota system in a distributed file system is provided. Each node manages a quota database tracking available quota for the node. Should additional quota be required, a node queries a remote node to obtain a lock over the remote quota database. The additional quota is shifted and remaining free quota is reallocated between the local and remote nodes.

This application is a continuation application of U.S. patent application Ser. No. 14/317,791 filed on Jun. 27, 2014 which is hereby incorporated by reference in its entirety.

### FIELD

The present disclosure is directed to distributed storage systems and, more particularly to implementing a quota system in a distributed storage system.

### BACKGROUND

Distributed file systems may utilize a plurality of flexible volumes that are hosted by a plurality of nodes organized as a cluster. The flexible volumes are logically joined together to provide a unified storage space. That is, the various flexible volumes are managed by separate nodes of a cluster but the storage space available on the plurality of flexible volumes appears as a single unified storage space accessible by clients of the distributed file system. A noted disadvantage of distributed file systems arises when implementing quota systems thereon. Conventional quota systems for use with distributed file systems are limited to implementing a soft quota system in which a user may exceed his defined quota capacity by some amount. This contrasts with a hard quota system where users are prohibited from exceeding their limit.

### BRIEF DESCRIPTION OF THE DRAWINGS

The above and further advantages of the disclosure may be better understood by referring to the following description in conjunction with the accompanying drawings in which like reference numerals indicate identical or functionally similar elements:

FIG. 1 is an exemplary schematic block diagram of a plurality of nodes interconnected as a cluster;

FIG. 2 is an exemplary schematic block diagram of a node;

FIG. 3 is an exemplary schematic block diagram of a storage operating system;

FIG. 4 is an exemplary schematic block diagram illustrating the format of a cluster fabric (CF) message;

FIG. 5 is an exemplary schematic block diagram of an inode;

FIG. 6 is an exemplary schematic block diagram of a buffer tree;

FIG. 7 is an exemplary schematic block diagram of a buffer tree of a file;

FIG. 8 is an exemplary schematic block diagram of an aggregate;

FIG. 9 is an exemplary schematic block diagram of an on-disk layout of the aggregate;

FIG. 10 is an exemplary schematic block diagram of a quota data structure; and

FIG. 11 is an exemplary block diagram of a management framework and

volume location database;

FIG. 12 is a flow chart detailing the steps of a procedure for initial assignment of a quota among flexible volumes of a distributed file system;

FIG. 13 is a flow chart detailing the steps of a procedure for initially distributing quota among flexible volumes of a distributed file system;

FIG. 14 is a flow chart detailing the steps of a procedure for reallocating quota among a plurality of flexible volumes;

FIG. 15 is a flow chart detailing the steps of a procedure for reallocating quota among a plurality of flexible volumes;

FIG. 16 is a flow chart detailing the steps of a procedure for reallocating quota among a plurality of flexible volumes; and

FIG. 17 is a flow chart detailing the steps of a procedure for returning freed quota to a repository.

### DETAILED DESCRIPTION

The subject matter of the disclosure is directed to a system and method for implementing a quota system within a distributed file system. In a first aspect of the disclosure, when an administrator assigns a quota to a user in a distributed file system, each of the N flexible volumes comprising the distributed file system is assigned 1/N of the total quota. In a second aspect of the disclosure, the entire quota is assigned to a first flexible volume. During operation, should a data access request be directed to a local flexible volume that would cause the local flexible volume to exceed its local quota limit, a quota module executing on the note in servicing the local flexible module queries other nodes to determine if they have available quota. Should there be available quota, quota is transferred from the remote flexible volume to the local flexible volume to enable the data access request to be processed. In this way, data access operations may be processed up to the limit of the quota associated with the user on the distributed file system.

### Cluster Environment

A storage system typically comprises one or more storage devices into which information may be entered, and from which information may be obtained, as desired. The storage system includes a storage operating system that functionally organizes the system by, inter alia, invoking storage operations in support of a storage service implemented by the system. The storage system may be implemented in accordance with a variety of storage architectures including, but not limited to, a network-attached storage environment, a storage area network and a disk assembly directly attached to a client or host computer. The storage devices are typically disk drives organized as a disk array, wherein the term “disk” commonly describes a self-contained rotating magnetic media storage device. The term disk in this context is synonymous with hard disk drive (HDD) or direct access storage device (DASD).

The storage operating system of the storage system may implement a high-level module, such as a file system, to logically organize the information stored on volumes as a hierarchical structure of data containers, such as files and logical units. For example, each “on-disk” file may be implemented as a set of data structures, i.e., disk blocks, configured to store information, such as the actual data for the file. These data blocks are organized within a volume block number (vbn) space that is maintained by the file system. The file system may also assign each data block in the file a corresponding “file offset” or file block number (fbn). The file system typically assigns sequences of fbns on a per-file basis, whereas vbns are assigned over a larger volume address space. The file system organizes the data blocks within the vbn space as a “logical volume”; each logical volume may be, although is not necessarily, associated with its own file system.

A known type of file system is a write anywhere file system that does not overwrite data on disks. If a data block is retrieved (read) from disk into a memory of the storage system and “dirtied” (i.e., updated or modified) with new data, the data block is thereafter stored (written) to a new location on disk to optimize write performance. A write-anywhere file system may initially assume an optimal layout such that the data is substantially contiguously arranged on disks. The optimal disk layout results in efficient access operations, particularly for sequential read operations, directed to the disks.

The storage system may be further configured to operate according to a client/server model of information delivery to thereby allow many clients to access data containers stored on the system. In this model, the client may comprise an application, such as a database application, executing on a computer that “connects” to the storage system over a computer network, such as a point-to-point link, shared local area network (LAN), wide area network (WAN), or virtual private network (VPN) implemented over a public network such as the Internet. Each client may request the services of the storage system by issuing file-based and block-based protocol messages (in the form of packets) to the system over the network.

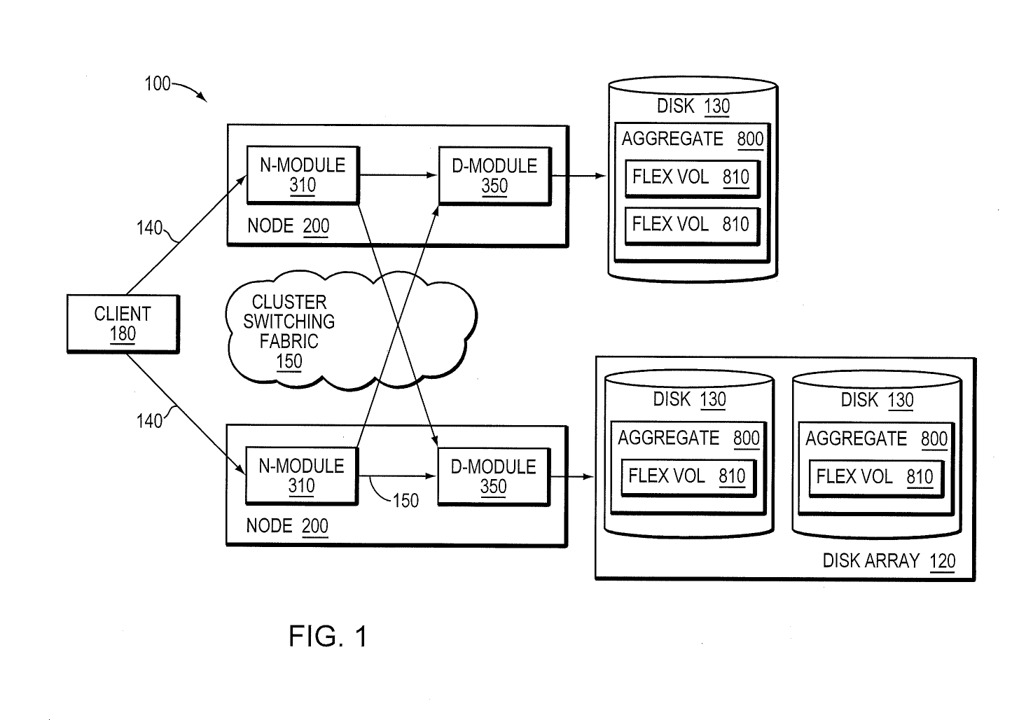

FIG. 1 is a schematic block diagram of a plurality of nodes 200 interconnected as a cluster 100 and configured to provide storage service relating to the organization of information on storage devices. The nodes 200 comprise various functional components that cooperate to provide a distributed storage system architecture of the cluster 100. To that end, each node 200 is generally organized as a network element (N-module 310) and a disk element (D-module 350). The N-module 310 includes functionality that enables the node 200 to connect to clients 180 over a computer network 140, while each D-module 350 connects to one or more storage devices, such as disks 130 of a disk array 120. The nodes 200 are interconnected by a cluster switching fabric 150 which, in the illustrative embodiment, may be embodied as a Gigabit Ethernet switch. An exemplary distributed file system architecture is generally described in U.S. Pat. No. 6,671,773 titled METHOD AND SYSTEM FOR RESPONDING TO FILE SYSTEM REQUESTS, by M. Kazar et al., issued Dec. 30, 2003. It should be noted that while there is shown an equal number of N and D-modules in the illustrative cluster 100, there may be differing numbers of N and/or D-modules in accordance with various embodiments of the present invention. For example, there may be a plurality of N-modules and/or D-modules interconnected in a cluster configuration 100 that does not reflect a one-to-one correspondence between the N and D-modules. As such, the description of a node 200 comprising one N-module and one D-module should be taken as illustrative only.

The clients 180 may be general-purpose computers configured to interact with the node 200 in accordance with a client/server model of information delivery. That is, each client may request the services of the node, and the node may return the results of the services requested by the client, by exchanging packets over the network 140. The client may issue packets including file-based access protocols, such as the Common Internet File System (CIFS) protocol or Network File System (NFS) protocol, over the Transmission Control Protocol/Internet Protocol (TCP/IP) when accessing information in the form of files and directories. Alternatively, the client may issue packets including block-based access protocols, such as the Small Computer Systems Interface (SCSI) protocol encapsulated over TCP (iSCSI) and SCSI encapsulated over Fibre Channel (FCP), when accessing information in the form of blocks.

D-modules 350 are illustratively connected to disks 130, that may be organized into disk arrays 120. In alternative embodiments, storage devices other than disks may be utilized, e.g., flash memory, optical storage, solid state devices, etc. As such, the description of disks should be taken as exemplary only.

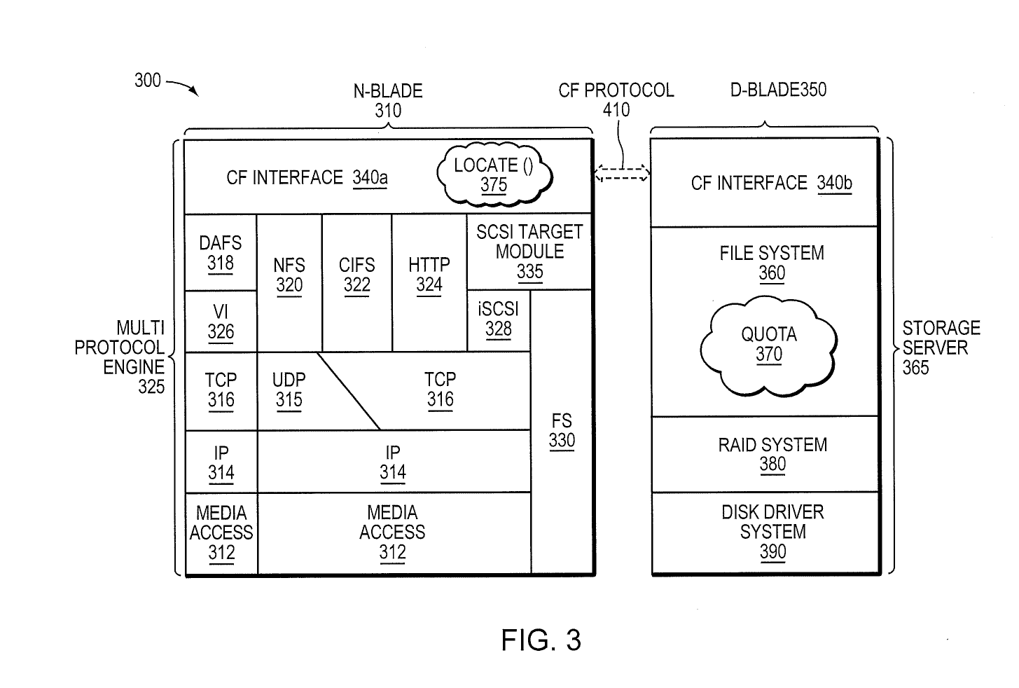

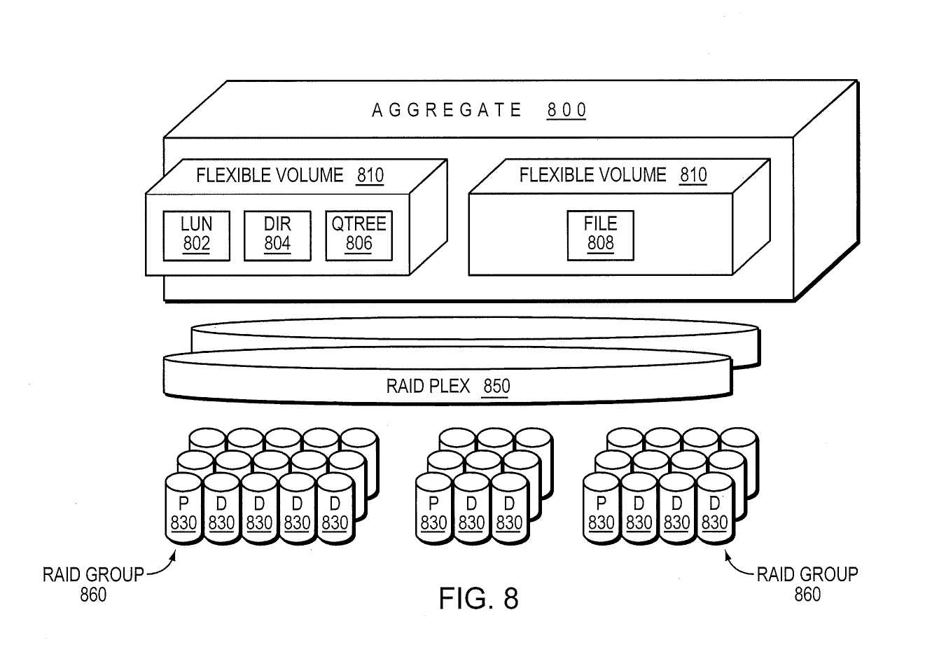

As described below, in reference to FIG. 3, a file system 360 may implement a plurality of flexible volumes 810 on the disks 130. Illustratively, flexible volumes may be organized to form a distributed file system. Illustratively, the flexible volumes 810 may be contain within aggregates 800, described further below in reference to FIG. 8. However, it should be noted that the description of flexible volumes within aggregates should be taken as exemplary only. As such the principles of the present disclosure may be utilized in any form of volumes and being organized into a distributed file system.

### Storage System Node

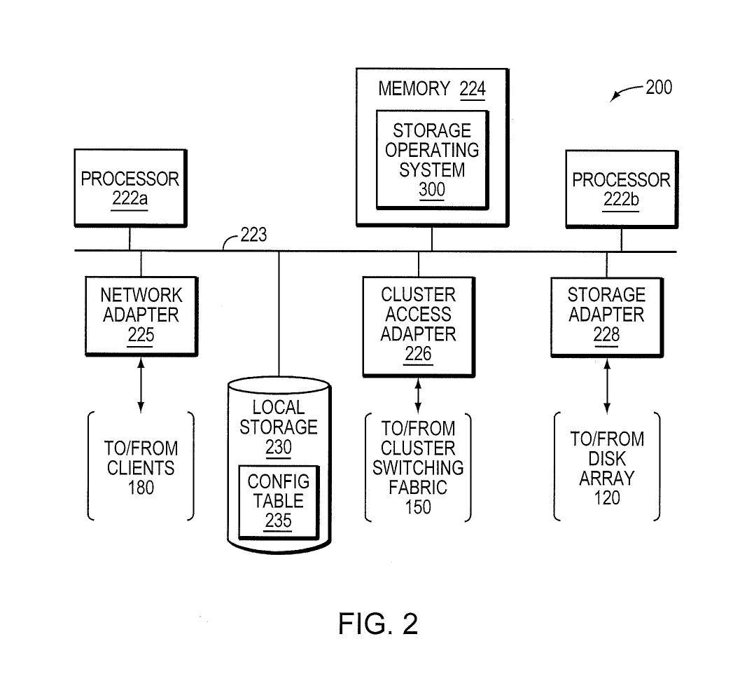

FIG. 2 is a schematic block diagram of a node 200 that is illustratively embodied as a storage system comprising a plurality of processors 222a,b, a memory 224, a network adapter 225, a cluster access adapter 226, a storage adapter 228 and local storage 230 interconnected by a system bus 223. The local storage 230 comprises one or more storage devices, such as disks, utilized by the node to locally store configuration information (e.g., in configuration table 235). The cluster access adapter 226 comprises a plurality of ports adapted to couple the node 200 to other nodes of the cluster 100. In the illustrative embodiment, Ethernet is used as the clustering protocol and interconnect media, although it will be apparent to those skilled in the art that other types of protocols and interconnects may be utilized within the cluster architecture described herein. In alternate embodiments where the N-modules and D-modules are implemented on separate storage systems or computers, the cluster access adapter 226 is utilized by the N/D-module for communicating with other N/D-modules in the cluster 100.

Each node 200 is illustratively embodied as a dual processor storage system executing a storage operating system 300 that preferably implements a high-level module, such as a file system, to logically organize the information as a hierarchical structure of named directories, files and special types of files called virtual disks (hereinafter generally “blocks”) on the disks. However, it will be apparent to those of ordinary skill in the art that the node 200 may alternatively comprise a single or more than two processor system. Illustratively, one processor 222a executes the functions of the N-module 310 on the node, while the other processor 222b executes the functions of the D-module 350.

The memory 224 illustratively comprises storage locations that are addressable by the processors and adapters for storing software program code and data structures associated with the present invention. The processor and adapters may, in turn, comprise processing elements and/or logic circuitry configured to execute the software code and manipulate the data structures. The storage operating system 300, portions of which is typically resident in memory and executed by the processing elements, functionally organizes the node 200 by, inter alia, invoking storage operations in support of the storage service implemented by the node. It will be apparent to those skilled in the art that other processing and memory means, including various computer readable media, may be used for storing and executing program instructions pertaining to the invention described herein.

The network adapter 225 comprises a plurality of ports adapted to couple the node 200 to one or more clients 180 over point-to-point links, wide area networks, virtual private networks implemented over a public network (Internet) or a shared local area network. The network adapter 225 thus may comprise the mechanical, electrical and signaling circuitry needed to connect the node to the network. Illustratively, the computer network 140 may be embodied as an Ethernet network or a Fibre Channel (FC) network. Each client 180 may communicate with the node over network 140 by exchanging discrete frames or packets of data according to pre-defined protocols, such as TCP/IP.

The storage adapter 228 cooperates with the storage operating system 300 executing on the node 200 to access information requested by the clients. The information may be stored on any type of attached array of writable storage device media such as video tape, optical, DVD, magnetic tape, bubble memory, electronic random access memory, micro-electro mechanical and any other similar media adapted to store information, including data and parity information. However, as illustratively described herein, the information is stored on the disks 130 of array 120. The storage adapter comprises a plurality of ports having input/output (I/O) interface circuitry that couples to the disks over an I/O interconnect arrangement, such as a conventional high-performance, FC link topology.

Storage of information on each array 120 is preferably implemented as one or more storage “volumes” that comprise a collection of physical storage disks 130 cooperating to define an overall logical arrangement of volume block number (vbn) space on the volume(s). Each logical volume is generally, although not necessarily, associated with its own file system. The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used in accordance with the inventive principles described herein.

### Storage Operating System

To facilitate access to the disks 130, the storage operating system 300 implements a write-anywhere file system that cooperates with one or more virtualization modules to “virtualize” the storage space provided by disks 130. The file system logically organizes the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization module(s) allow the file system to further logically organize information as a hierarchical structure of blocks on the disks that are exported as named logical unit numbers (luns).

[Illustratively, the storage operating system is the Data ONTAP® operating system available from NetApp, Inc., Sunnyvale, Calif. that implements a Write Anywhere File Layout (WAFL®) file system. However, it is expressly contemplated that any appropriate storage operating system may be enhanced for use in accordance with the inventive principles described herein.

FIG. 3 is a schematic block diagram of an exemplary storage operating system 300. The storage operating system 300 comprises a series of software layers organized to form an integrated network protocol stack or, more generally, a multi-protocol engine 325 that provides data paths for clients to access information stored on the node using block and file access protocols. The multi-protocol engine includes a media access layer 312 of network drivers (e.g., gigabit Ethernet drivers) that interfaces to network protocol layers, such as the IP layer 314 and its supporting transport mechanisms, the TCP layer 316 and the User Datagram Protocol (UDP) layer 315. A file system protocol layer provides multi-protocol file access and, to that end, includes support for the Direct Access File System (DAFS) protocol 318, the NFS protocol 320, the CIFS protocol 322 and the Hypertext Transfer Protocol (HTTP) protocol 324. A VI layer 326 implements the VI architecture to provide direct access transport (DAT) capabilities, such as RDMA, as required by the DAFS protocol 318. An iSCSI driver layer 328 provides block protocol access over the TCP/IP network protocol layers, while a FC driver layer 330 receives and transmits block access requests and responses to and from the node. The FC and iSCSI drivers provide FC-specific and iSCSI-specific access control to the blocks and, thus, manage exports of luns to either iSCSI or FCP or, alternatively, to both iSCSI and FCP when accessing the blocks on the node 200.

In addition, the storage operating system includes a series of software layers organized to form a storage server 365 that provides data paths for accessing information stored on the disks 130 of the node 200. To that end, the storage server 365 includes a file system module 360, including a quota module 370, a RAID system module 380 and a disk driver system module 390. The RAID system 380 manages the storage and retrieval of information to and from the volumes/disks in accordance with I/O operations, while the disk driver system 390 implements a disk access protocol such as, e.g., the SCSI protocol.

The file system 360 implements a virtualization system of the storage operating system 300 through the interaction with one or more virtualization modules illustratively embodied as, e.g., a virtual disk (vdisk) module (not shown) and a SCSI target module 335. The SCSI target module 335 is generally disposed between the FC and iSCSI drivers 328, 330 and the file system 360 to provide a translation layer of the virtualization system between the block (lun) space and the file system space, where luns are represented as blocks.

The file system 360 is illustratively a message-based system that provides logical volume management capabilities for use in access to the information stored on the storage devices, such as disks. That is, in addition to providing file system semantics, the file system 360 provides functions normally associated with a volume manager. These functions include (i) aggregation of the disks, (ii) aggregation of storage bandwidth of the disks, and (iii) reliability guarantees, such as mirroring and/or parity (RAID). The file system 360 illustratively implements an exemplary write anywhere file system having an on-disk format representation that is block-based using, e.g., 4 kilobyte (kB) blocks and using index nodes (“inodes”) to identify files and file attributes (such as creation time, access permissions, size and block location). The file system uses files to store meta-data describing the layout of its file system; these meta-data files include, among others, an inode file. A file handle, i.e., an identifier that includes an inode number, is used to retrieve an inode from disk.

Broadly stated, all inodes of the file system are organized into the inode file. A file system (fs) info block specifies the layout of information in the file system and includes an inode of a file that includes all other inodes of the file system. Each logical volume (file system) has an fsinfo block that is preferably stored at a fixed location within, e.g., a RAID group. The inode of the inode file may directly reference (point to) data blocks of the inode file or may reference indirect blocks of the inode file that, in turn, reference data blocks of the inode file. Within each data block of the inode file are embedded inodes, each of which may reference indirect blocks that, in turn, reference data blocks of a file.

Operationally, a request from the client 180 is forwarded as a packet over the computer network 140 and onto the node 200 where it is received at the network adapter 225. A network driver (of layer 312 or layer 330) processes the packet and, if appropriate, passes it on to a network protocol and file access layer for additional processing prior to forwarding to the file system 360. Here, the file system generates operations to load (retrieve) the requested data from disk 130 if it is not resident “in core”, i.e., in memory 224. If the information is not in memory, the file system 360 indexes into the inode file using the inode number to access an appropriate entry and retrieve a logical vbn. The file system then passes a message structure including the logical vbn to the RAID system 380; the logical vbn is mapped to a disk identifier and disk block number (disk,dbn) and sent to an appropriate driver (e.g., SCSI) of the disk driver system 390. The disk driver accesses the dbn from the specified disk 130 and loads the requested data block(s) in memory for processing by the node. Upon completion of the request, the node (and operating system) returns a reply to the client 180 over the network 140.

The quota module 370 operatively is illustratively implemented as part of the file system 360. However, it should be noted that in alternative aspects, the quota module 370 may be implemented separately from the file system 360. As such, the description of the quota module 370 being a component of the file system 360 should be taken as exemplary only. Illustratively, the quota module 370 implements the quota mechanism, described further below; however, it should be noted that in alternative aspects of the present disclosure, the quota functionality may be directly embedded in the file system 360 or within other modules with storage operating system 300. As such, the description of a dedicated quota module 370 should be taken as exemplary only.

It should be noted that the software “path” through the storage operating system layers described above needed to perform data storage access for the client request received at the node may alternatively be implemented in hardware. That is, in an alternate embodiment of the invention, a storage access request data path may be implemented as logic circuitry embodied within a field programmable gate array (FPGA) or an application specific integrated circuit (ASIC). This type of hardware implementation increases the performance of the storage service provided by node 200 in response to a request issued by client 180. Moreover, in another alternate embodiment of the invention, the processing elements of adapters 225, 228 may be configured to offload some or all of the packet processing and storage access operations, respectively, from processor 222, to thereby increase the performance of the storage service provided by the node. It is expressly contemplated that the various processes, architectures and procedures described herein can be implemented in hardware, firmware or software.

As used herein, the term “storage operating system” generally refers to the computer-executable code operable on a computer to perform a storage function that manages data access and may, in the case of a node 200, implement data access semantics of a general purpose operating system. The storage operating system can also be implemented as a microkernel, an application program operating over a general-purpose operating system, such as UNIX® or Windows NT®, or as a general-purpose operating system with configurable functionality, which is configured for storage applications as described herein.

In addition, it will be understood to those skilled in the art that the invention described herein may apply to any type of special-purpose (e.g., file server, filer or storage serving appliance) or general-purpose computer, including a standalone computer or portion thereof, embodied as or including a storage system. Moreover, the teachings of this invention can be adapted to a variety of storage system architectures including, but not limited to, a network-attached storage environment, a storage area network and disk assembly directly-attached to a client or host computer. The term “storage system” should therefore be taken broadly to include such arrangements in addition to any subsystems configured to perform a storage function and associated with other equipment or systems. It should be noted that while this description is written in terms of a write anywhere file system, the teachings of the present invention may be utilized with any suitable file system, including a write in place file system.

### CF Protocol

In the illustrative embodiment, the storage server 365 is embodied as D-module 350 of the storage operating system 300 to service one or more volumes of array 120. In addition, the multi-protocol engine 325 is embodied as N-module 310 to (i) perform protocol termination with respect to a client issuing incoming data access request packets over the network 140, as well as (ii) redirect those data access requests to any storage server 365 of the cluster 100. Moreover, the N-module 310 and D-module 350 cooperate to provide a highly-scalable, distributed storage system architecture of the cluster 100. To that end, each module includes a cluster fabric (CF) interface module 340a,b adapted to implement intra-cluster communication among the modules, including D-module-to-D-module communication for data container striping operations described herein.

The protocol layers, e.g., the NFS/CIFS layers and the iSCSI/FC layers, of the N-module 310 function as protocol servers that translate file-based and block based data access requests from clients into CF protocol messages used for communication with the D-module 350. That is, the N-module servers convert the incoming data access requests into file system primitive operations (commands) that are embedded within CF messages by the CF interface module 340 for transmission to the D-modules 350 of the cluster 100. Notably, the CF interface modules 340 cooperate to provide a single file system image across all D-modules 350 in the cluster 100. Thus, any network port of an N-module that receives a client request can access any data container within the single file system image located on any D-module 350 of the cluster.

Further to an illustrative embodiment, the N-module 310 and D-module 350 are implemented as separately-scheduled processes of storage operating system 300; however, in an alternate embodiment, the modules may be implemented as pieces of code within a single operating system process. Communication between an N-module and D-module is thus illustratively effected through the use of message passing between the modules although, in the case of remote communication between an N-module and D-module of different nodes, such message passing occurs over the cluster switching fabric 150. A known message-passing mechanism provided by the storage operating system to transfer information between modules (processes) is the Inter Process Communication (IPC) mechanism. The protocol used with the IPC mechanism is illustratively a generic file and/or block-based “agnostic” CF protocol that comprises a collection of methods/functions constituting a CF application programming interface (API). Examples of such an agnostic protocol are the SpinFS and SpinNP protocols available from NetApp, Inc. The SpinFS protocol is described in the above-referenced U.S. Pat. Patent No. 6,671,773.

The CF interface module 340 implements the CF protocol for communicating file system commands among the modules of cluster 100. Communication is illustratively effected by the D-module exposing the CF API to which an N-module (or another D-module) issues calls. To that end, the CF interface module 340 is organized as a CF encoder and CF decoder. The CF encoder of, e.g., CF interface 340a on N-module 310 encapsulates a CF message as (i) a local procedure call (LPC) when communicating a file system command to a D-module 350 residing on the same node 200 or (ii) a remote procedure call (RPC) when communicating the command to a D-module residing on a remote node of the cluster 100. In either case, the CF decoder of CF interface 340b on D-module 350 de-encapsulates the CF message and processes the file system command.

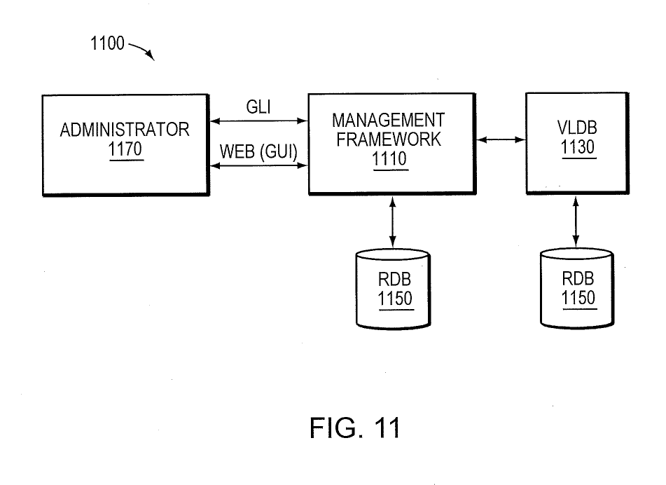

In an illustrative embodiment, the remote access module 370 may utilize CF messages to communicate with remote nodes to collect information relating to remote flexible volumes. Such information gathering is described below in reference to FIG. 11.

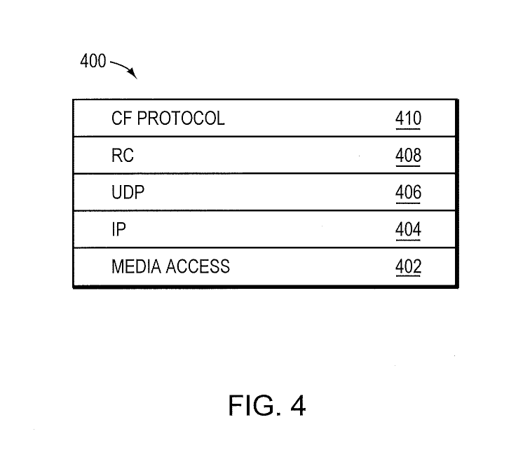

FIG. 4 is a schematic block diagram illustrating the format of a CF message 400 in accordance with an embodiment of with the present invention. The CF message 400 is illustratively used for RPC communication over the switching fabric 150 between remote modules of the cluster 100; however, it should be understood that the term “CF message” may be used generally to refer to LPC and RPC communication between modules of the cluster. The CF message 400 includes a media access layer 402, an IP layer 404, a UDP layer 406, a reliable connection (RC) layer 408 and a CF protocol layer 410. As noted, the CF protocol is a generic file system protocol that conveys file system commands related to operations contained within client requests to access data containers stored on the cluster 100; the CF protocol layer 410 is that portion of message 400 that carries the file system commands. Illustratively, the CF protocol is datagram based and, as such, involves transmission of messages or “envelopes” in a reliable manner from a source (e.g., an N-module 310) to a destination (e.g., a D-module 350). The RC layer 408 implements a reliable transport protocol that is adapted to process such envelopes in accordance with a connectionless protocol, such as UDP 406.

### File System Organization

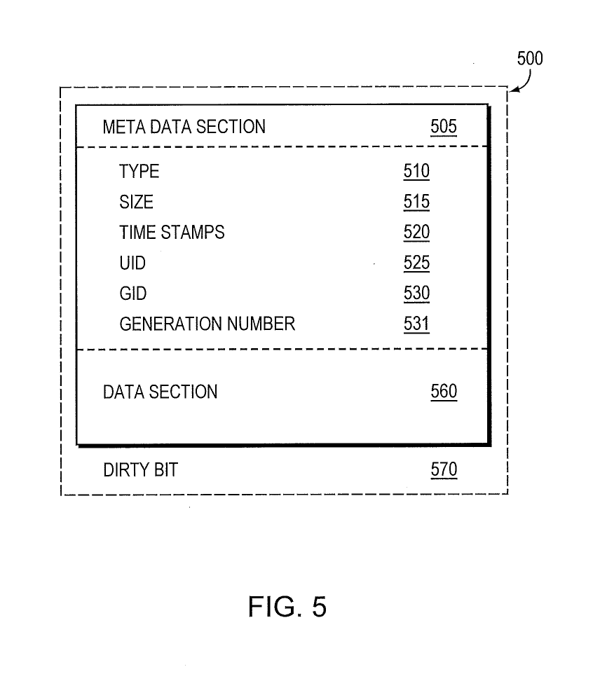

Illustratively, a data container is represented in the write-anywhere file system as an inode data structure adapted for storage on the disks 130. FIG. 5 is a schematic block diagram of an inode 500, which preferably includes a meta-data section 505 and a data section 560. The information stored in the meta-data section 505 of each inode 500 describes the data container (e.g., a file) and, as such, includes the type (e.g., regular, directory, vdisk) 510 of file, its size 515, time stamps (e.g., access and/or modification time)520 and ownership, i.e., user identifier (UID 525) and group ID (GID 530), of the file, and a generation number 531. The contents of the data section 560 of each inode may be interpreted differently depending upon the type of file (inode) defined within the type field 510. For example, the data section 560 of a directory inode contains meta-data controlled by the file system, whereas the data section of a regular inode contains file system data. In this latter case, the data section 560 includes a representation of the data associated with the file.

Specifically, the data section 560 of a regular on-disk inode may include file system data or pointers, the latter referencing 4 KB data blocks on disk used to store the file system data. Each pointer is preferably a logical vbn to facilitate efficiency among the file system and the RAID system 380 when accessing the data on disks. Given the restricted size (e.g., 128 bytes) of the inode, file system data having a size that is less than or equal to 64 bytes is represented, in its entirety, within the data section of that inode. However, if the length of the contents of the data container exceeds 64 bytes but less than or equal to 64 KB, then the data section of the inode (e.g., a first level inode) comprises up to 16 pointers, each of which references a 4 KB block of data on the disk.

Moreover, if the size of the data is greater than 64 KB but less than or equal to 64 megabytes (MB), then each pointer in the data section 560 of the inode (e.g., a second level inode) references an indirect block (e.g., a first level L1 block) that contains 1024 pointers, each of which references a 4 KB data block on disk. For file system data having a size greater than 64 B, each pointer in the data section 560 of the inode (e.g., a third level L3 inode) references a double-indirect block (e.g., a second level L2 block) that contains 1024 pointers, each referencing an indirect (e.g., a first level L1) block. The indirect block, in turn, that contains 1024 pointers, each of which references a 4 kB data block on disk. When accessing a file, each block of the file may be loaded from disk 130 into the memory 224.

When an on-disk inode (or block) is loaded from disk 130 into memory 224, its corresponding in-core structure embeds the on-disk structure. For example, the dotted line surrounding the inode 500 indicates the in-core representation of the on-disk inode structure. The in-core structure is a block of memory that stores the on-disk structure plus additional information needed to manage data in the memory (but not on disk). The additional information may include, e.g., a “dirty” bit 570. After data in the inode (or block) is updated/modified as instructed by, e.g., a write operation, the modified data is marked “dirty” using the dirty bit 570 so that the inode (block) can be subsequently “flushed” (stored) to disk. The in-core and on-disk format structures of the WAFL file system, including the inodes and inode file, are disclosed and described in the previously incorporated U.S. Pat. No. 5,819,292 titled METHOD FOR MAINTAINING CONSISTENT STATES OF A FILE SYSTEM AND FOR CREATING USER-ACCESSIBLE READ-ONLY COPIES OF A FILE SYSTEM by David Hitz et al., issued on Oct. 6, 1998.

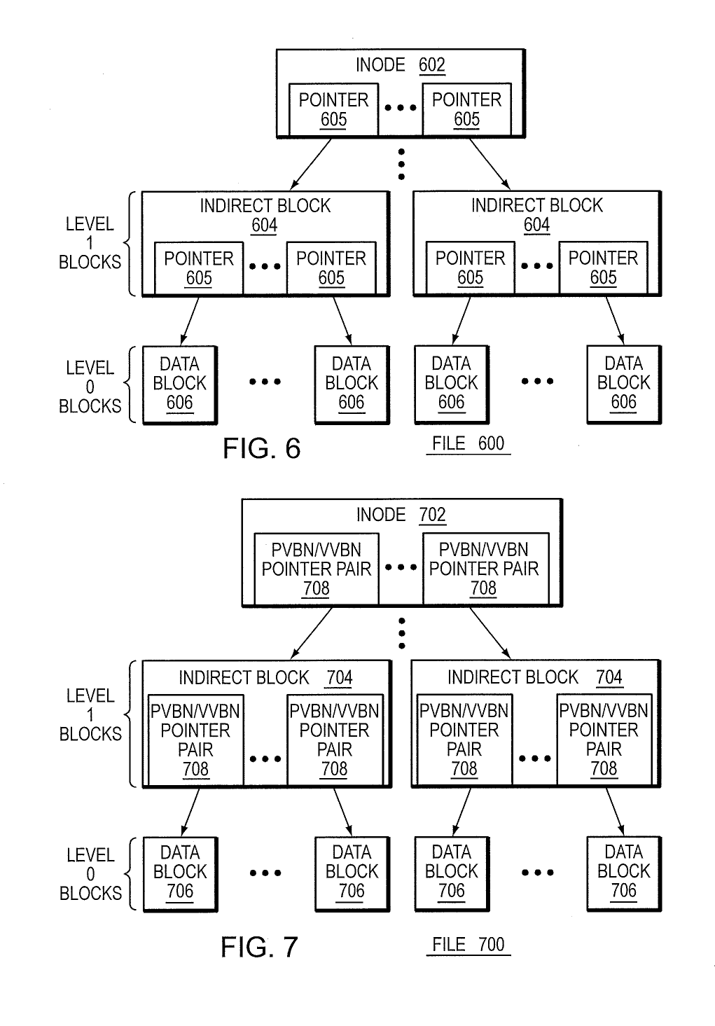

FIG. 6 is a schematic block diagram of an embodiment of a buffer tree of a file 600 that may be advantageously used with the present invention. The buffer tree is an internal representation of blocks for a file (e.g., file 600) loaded into the memory 224 and maintained by the write-anywhere file system 360. A root (top-level) inode 602, such as an embedded inode, references indirect (e.g., level 1) blocks 604. Note that there may be additional levels of indirect blocks (e.g., level 2, level 3) depending upon the size of the file. The indirect blocks (and inode) contain pointers 605 that ultimately reference data blocks 606 used to store the actual data of the file. That is, the data of file 600 are contained in data blocks and the locations of these blocks are stored in the indirect blocks of the file. Each level 1 indirect block 604 may contain pointers to as many as 1024 data blocks. According to the “write anywhere” nature of the file system, these blocks may be located anywhere on the disks 130.

A file system layout is provided that apportions an underlying physical volume into one or more virtual volumes (or flexible volume) of a storage system, such as node 200. An example of such a file system layout is described in U.S. Pat. No. 7,409,494 titled EXTENSION OF WRITE ANYWHERE FILE SYSTEM LAYOUT, by John K. Edwards et al. and assigned to NetApp, Inc. The underlying physical volume is an aggregate comprising one or more groups of disks, such as RAID groups, of the node. The aggregate has its own physical volume block number (pvbn) space and maintains meta-data, such as block allocation structures, within that pvbn space. Each flexible volume has its own virtual volume block number (vvbn) space and maintains meta-data, such as block allocation structures, within that vvbn space. Each flexible volume is a file system that is associated with a container file; the container file is a file in the aggregate that contains all blocks used by the flexible volume. Moreover, each flexible volume comprises data blocks and indirect blocks that contain block pointers that point at either other indirect blocks or data blocks.

In one embodiment, pvbns are used as block pointers within buffer trees of files (such as file 600) stored in a flexible volume. This “hybrid” flexible volume embodiment involves the insertion of only the pvbn in the parent indirect block (e.g., inode or indirect block). On a read path of a logical volume, a “logical” volume (vol) info block has one or more pointers that reference one or more fsinfo blocks, each of which, in turn, points to an inode file and its corresponding inode buffer tree. The read path on a flexible volume is generally the same, following pvbns (instead of vvbns) to find appropriate locations of blocks; in this context, the read path (and corresponding read performance) of a flexible volume is substantially similar to that of a physical volume. Translation from pvbn-to-disk,dbn occurs at the file system/RAID system boundary of the storage operating system 300.

In an illustrative dual vbn hybrid flexible volume embodiment, both a pvbn and its corresponding vvbn are inserted in the parent indirect blocks in the buffer tree of a file. That is, the pvbn and vvbn are stored as a pair for each block pointer in most buffer tree structures that have pointers to other blocks, e.g., level 1 (L1) indirect blocks, inode file level 0 (L0) blocks. FIG. 7 is a schematic block diagram of an illustrative embodiment of a buffer tree of a file 700 that may be advantageously used with the present invention. A root (top-level) inode 702, such as an embedded inode, references indirect (e.g., level 1) blocks 704. Note that there may be additional levels of indirect blocks (e.g., level 2, level 3) depending upon the size of the file. The indirect blocks (and inode) contain pvbn/vvbn pointer pair structures 808 that ultimately reference data blocks 706 used to store the actual data of the file.

The pvbns reference locations on disks of the aggregate, whereas the vvbns reference locations within files of the flexible volume. The use of pvbns as block pointers 708 in the indirect blocks 704 provides efficiencies in the read paths, while the use of vvbn block pointers provides efficient access to required meta-data. That is, when freeing a block of a file, the parent indirect block in the file contains readily available vvbn block pointers, which avoids the latency associated with accessing an owner map to perform pvbn-to-vvbn translations; yet, on the read path, the pvbn is available.

FIG. 8 is a schematic block diagram of an embodiment of an aggregate 800 that may be advantageously used with the present invention. Luns (blocks) 802, directories 804, qtrees 806 and files 808 may be contained within flexible volumes 810, such as dual vbn flexible volumes, that, in turn, are contained within the aggregate 800. It should be noted that in accordance with illustrative embodiments of the present invention, the flexible volumes 810 including elements within the flexible volumes may comprise junctions to provide redirection information to other flexible volumes, which may be contained within the same aggregate 804, may be stored in aggregate service by other key modules in the distributed file system. Assets, the description of elements being stored within a flexible volume 810 should be taken as exemplary only. The aggregate 800 is illustratively layered on top of the RAID system, which is represented by at least one RAID plex 850 (depending upon whether the storage configuration is mirrored), wherein each plex 850 comprises at least one RAID group 860. Each RAID group further comprises a plurality of disks 830, e.g., one or more data (D) disks and at least one (P) parity disk.

Whereas the aggregate 800 is analogous to a physical volume of a conventional storage system, a flexible volume is analogous to a file within that physical volume. That is, the aggregate 800 may include one or more files, wherein each file contains a flexible volume 810 and wherein the sum of the storage space consumed by the flexible volumes is physically smaller than (or equal to) the size of the overall physical volume. The aggregate utilizes a physical pvbn space that defines a storage space of blocks provided by the disks of the physical volume, while each embedded flexible volume (within a file) utilizes a logical vvbn space to organize those blocks, e.g., as files. Each vvbn space is an independent set of numbers that corresponds to locations within the file, which locations are then translated to dbns on disks. Since the flexible volume 810 is also a logical volume, it has its own block allocation structures (e.g., active, space and summary maps) in its vvbn space.

A container file is a file in the aggregate that contains all blocks used by a flexible volume. The container file is an internal (to the aggregate) feature that supports a flexible volume; illustratively, there is one container file per flexible volume. Similar to a pure logical volume in a file approach, the container file is a hidden file (not accessible to a user) in the aggregate that holds every block in use by the flexible volume. The aggregate includes an illustrative hidden meta-data root directory that contains subdirectories of flexible volumes:

### WAFL/Fsid/Filesystem File, Storage Label File

Specifically, a physical file system (WAFL) directory includes a subdirectory for each flexible volume in the aggregate, with the name of subdirectory being a file system identifier (fsid) of the flexible volume. Each fsid subdirectory (flexible volume) contains at least two files, a filesystem file and a storage label file. The storage label file is illustratively a 4 kB file that contains meta-data similar to that stored in a conventional raid label. In other words, the storage label file is the analog of a raid label and, as such, contains information about the state of the flexible volume such as, e.g., the name of the flexible volume, a universal unique identifier (uuid) and fsid of the flexible volume, whether it is online, being created or being destroyed, etc.

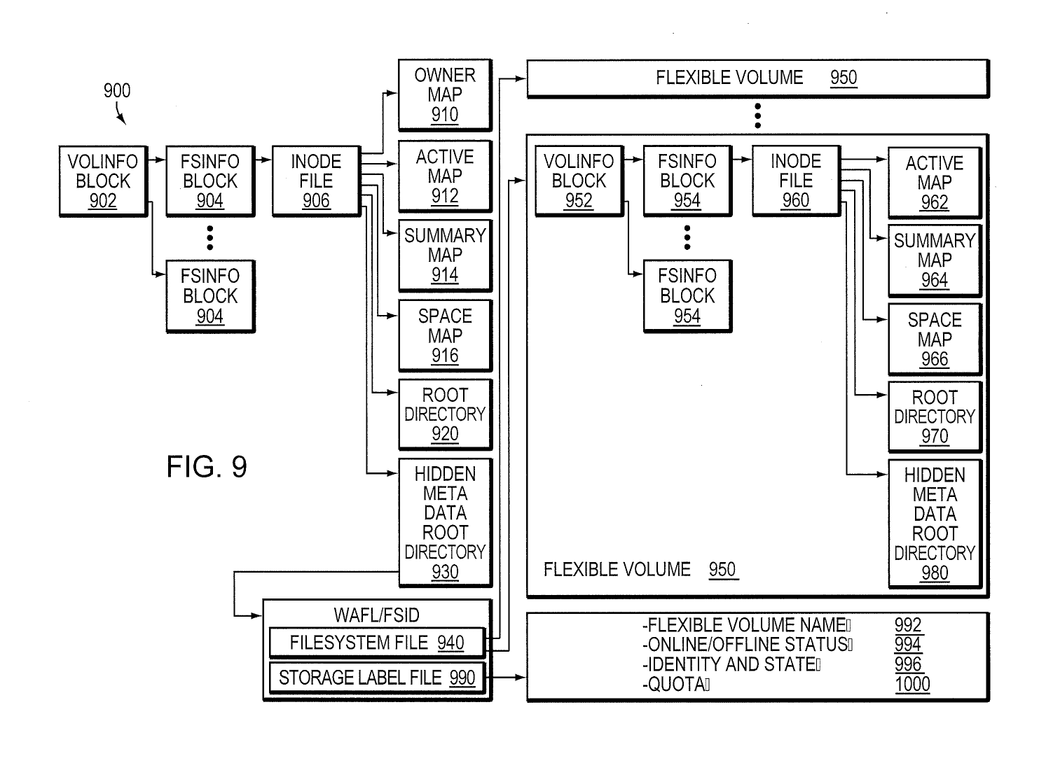

FIG. 9 is a schematic block diagram of an on-disk representation of an aggregate 900. The storage operating system 300, e.g., the RAID system 380, assembles a physical volume of pvbns to create the aggregate 900, with pvbns 1 and 2 comprising a “physical” volinfo block 902 for the aggregate. The volinfo block 902 contains block pointers to fsinfo blocks 904, each of which may represent a snapshot of the aggregate. Each fsinfo block 904 includes a block pointer to an inode file 906 that contains inodes of a plurality of files, including an owner map 910, an active map 912, a summary map 914 and a space map 916, as well as other special meta-data files. The inode file 906 further includes a root directory 920 and a “hidden” meta-data root directory 930, the latter of which includes a namespace having files related to a flexible volume in which users cannot “see” the files. The hidden meta-data root directory includes the WAFL/fsid/directory structure that contains filesystem file 940 and storage label file 990. Note that root directory 920 in the aggregate is empty; all files related to the aggregate are organized within the hidden meta-data root directory 930.

In addition to being embodied as a container file having level 1 blocks organized as a container map, the filesystem file 940 includes block pointers that reference various file systems embodied as flexible volumes 950. The aggregate 900 maintains these flexible volumes 950 at special reserved inode numbers. Each flexible volume 950 also has special reserved inode numbers within its flexible volume space that are used for, among other things, the block allocation bitmap structures. As noted, the block allocation bitmap structures, e.g., active map 962, summary map 964 and space map 966, are located in each flexible volume.

Specifically, each flexible volume 950 has the same inode file structure/content as the aggregate, with the exception that there is no owner map and no WAFL/fsid/filesystem file, storage label file directory structure in a hidden meta-data root directory 980. To that end, each flexible volume 950 has a volinfo block 952 that points to one or more fsinfo blocks 954, each of which may represent a snapshot, along with the active file system of the flexible volume. Each fsinfo block, in turn, points to an inode file 960 that, as noted, has the same inode structure/content as the aggregate with the exceptions noted above. Each flexible volume 950 has its own inode file 960 and distinct inode space with corresponding inode numbers, as well as its own root (fsid) directory 970 and subdirectories of files that can be exported separately from other flexible volumes.

The storage label file 990 contained within the hidden meta-data root directory 930 of the aggregate is a small file that functions as an analog to a conventional raid label. A raid label includes physical information about the storage system, such as the volume name; that information is loaded into the storage label file 990. Illustratively, the storage label file 990 includes the name 992 of the associated flexible volume 950, the online/offline status 994 of the flexible volume, other identity and state information 996 of the associated flexible volume (whether it is in the process of being created or destroyed) as well as the quota database 1000 associated with the particular flexible volumes within the aggregate.

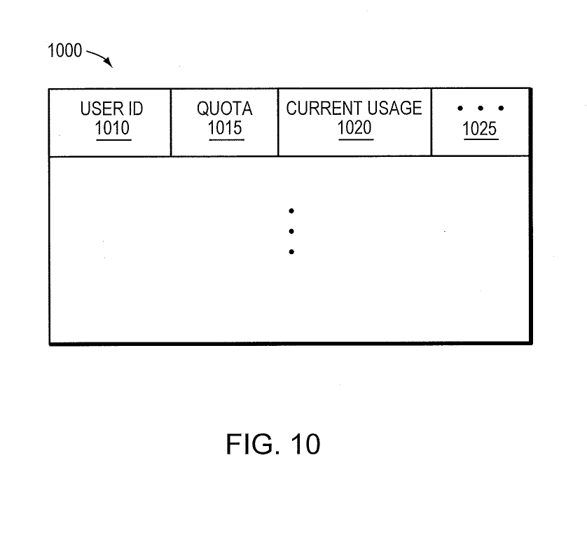

FIG. 10 is a block diagram of an exemplary quota database 1000. The quota database illustratively includes a plurality of entries 1005. Each entry 1005, which represents the quota associated with a particular user, comprises a user identifier field 1010, a quota field 1015, a current usage field 1020 and, in alternative aspects, additional fields 1025. The user ID field 1010 contains an identifier of the user with which the entry 1005 is associated. The quota field 1015 identifies the amount of quota that has been assigned to the user identified in the user ID field on this particular flexible volume. The current usage field 1020 contains the amount of space currently being utilized by the user on the flexible volume. In accordance with an aspect of the disclosure, the current usage 1020 may not exceed the quota 1015 assigned to the current user. Should a write operation be received that would cause the current usage to exceed the quota amount, the system will attempt to shift quota to the current flexible volume, as described further below.

### VLDB

FIG. 11 is a schematic block diagram illustrating a collection of management processes that execute as user mode applications 1100 on the storage operating system 300 to provide management of configuration information (i.e. management data) for the nodes of the cluster. To that end, the management processes include a management framework process 1110 and a volume location database (VLDB) process 1130, each utilizing a data replication service (RDB 1150) linked as a library. The management framework 1110 provides a user to an administrator 1170 interface via a command line interface (CLI) and/or a web-based graphical user interface (GUI). The management framework is illustratively based on a conventional common interface model (CIM) object manager that provides the entity to which users/system administrators interact with a node 200 in order to manage the cluster 100. The VLDB 1130 is a database process that tracks the locations of various storage components (e.g., SVSs, flexible volumes, aggregates, etc.) within the cluster 100 to thereby facilitate routing of requests throughout the cluster.

### Implementing A Quota System On A Distributed File System

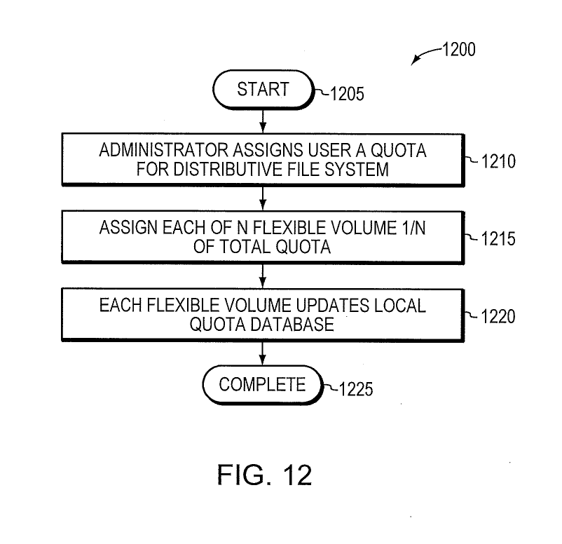

FIG. 12 is a flow chart detailing the steps of a procedure for initially distributing quota among a plurality of flexible volumes in a distributed file system. The procedure 1200 begins in step 1205 and continues to step 1210 where an administrator assigns a user a quota within the distributed file system. Illustratively, the administrator may utilize the management framework to assign the quota to the user. Such an assignment may be made by, for example, utilizing a graphical user interface (GUI) and/or command line interface (CLI) to assign the quota. In response to the assignment of the quota to a user, the quota module 370 assigns each of the N flexible volumes 1/N of the total quota in step 1215. That is, illustratively, the quota is divided evenly among each of the flexible volumes comprising the distributed file system. Each flexible volume updates its local quota database in step 1220. Once the local quota databases have been updated, the procedure 1200 then completes his step 1225.

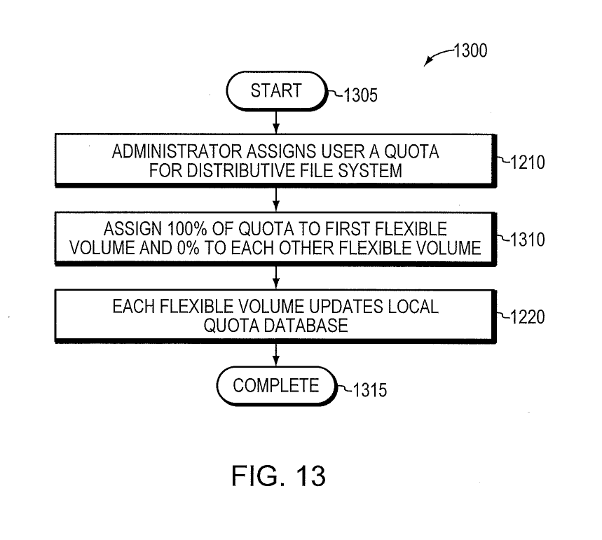

FIG. 13 is a flow chart detailing the steps of a procedure for initially assigning quota in a distributed file system. The procedure 1300 begins in step 1305 and continues to step 1210 where the administrator assigns a quota to a user for use with the distributed file system. In response to the initial assignment of the quota, 100% of the quota is assigned to a first flexible volume of the distributed file system with each other flexible volume being assigned 0% of the quota in step 1310. Once the official quota assignment has been made, each flexible volumes updates its local quota database in step 1220 before the procedure completes in step 1315. The various flexible volumes update their local quota database as described above in reference to FIG. 12.

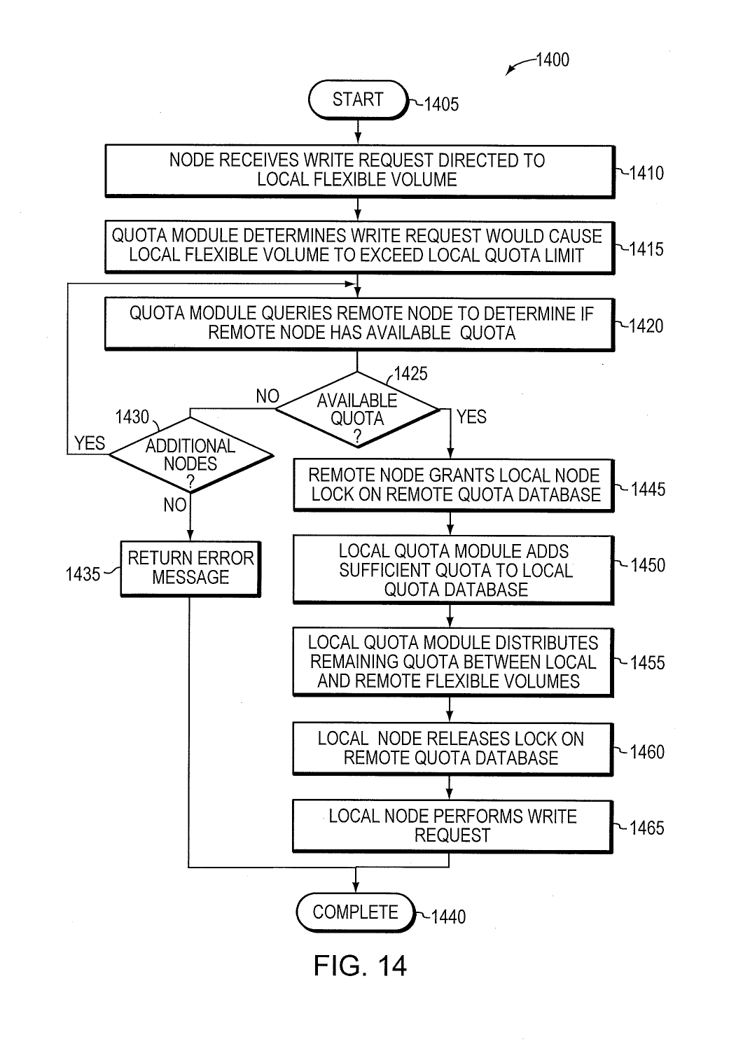

FIG. 14 is a flow chart detailing the steps of a procedure 1400 for reallocating quota among a plurality of flexible volumes. The procedure 1400 begins in step 1405 and continues to step 1410 where a node receives a write request directed to a local flexible volume. It should be noted that while a write operation is described in this example, other data access operations may utilize quota. More generally, the principles of the present disclosure may be utilized with any quota-consuming operation. As such, processing write operations should be taken as exemplary only. During processing of the write operation in step 1415, the quota module determines that the write request would cause the local flexible volume to exceed its local quota limit. That is, the current usage of the user on the flexible volume would exceed the assigned quota value 1015 in the corresponding entry in the quota database 1000. In response to determining that the local node does not have sufficient quota to service the write operation, the quota module then, in step 1420, queries a remote node to determine if the remote note has available quota. In step 1425, the remote node determines whether it has available quota to satisfy the request from the original node. This determination may be made by, for example, the quota module of the remote node examining its quota database to determine the current usage compared to the total quota assigned to a particular user for the flexible volume serviced by the remote node. If requested quota is not available, the procedure 1400 branches to step 1430 where the quota module on the local node determines whether there are additional nodes to query. If there are additional nodes, the procedure branches back to step 1420 where a different remote node is queried. However, if it is determined in step 1430 that no additional nodes exist, the procedure continues to step 1435 where an error message is returned. The procedure then completes in step 1440.

However, if in step 1425 it is determined that the remote node has available quota, then the procedure 1400 branches to step 1445 where the remote node grants the local node a lock on the remote node's quota database. Then, in step 1450 the local quota module adds sufficient quota to its local quota database. This may be accomplished by, for example, the local quota module adjusting the quota field within the entry associated with the user. The local quota module then distributes the remaining quota between the local and remote flexible volumes in step 1455. For example, if there is a total of 2 MB of quota remaining on the remote node, the quota module would reallocate that so that the local quota is increased by 1 MB and the remote quota is reduced by 1 MB so that both have an equal quota amount. The local quota module then releases the lock on the remote quota database in step 1460. As there is now sufficient quota available, the local node may then process the write operation in step 1465. The procedure 1400 completes in step 1440.

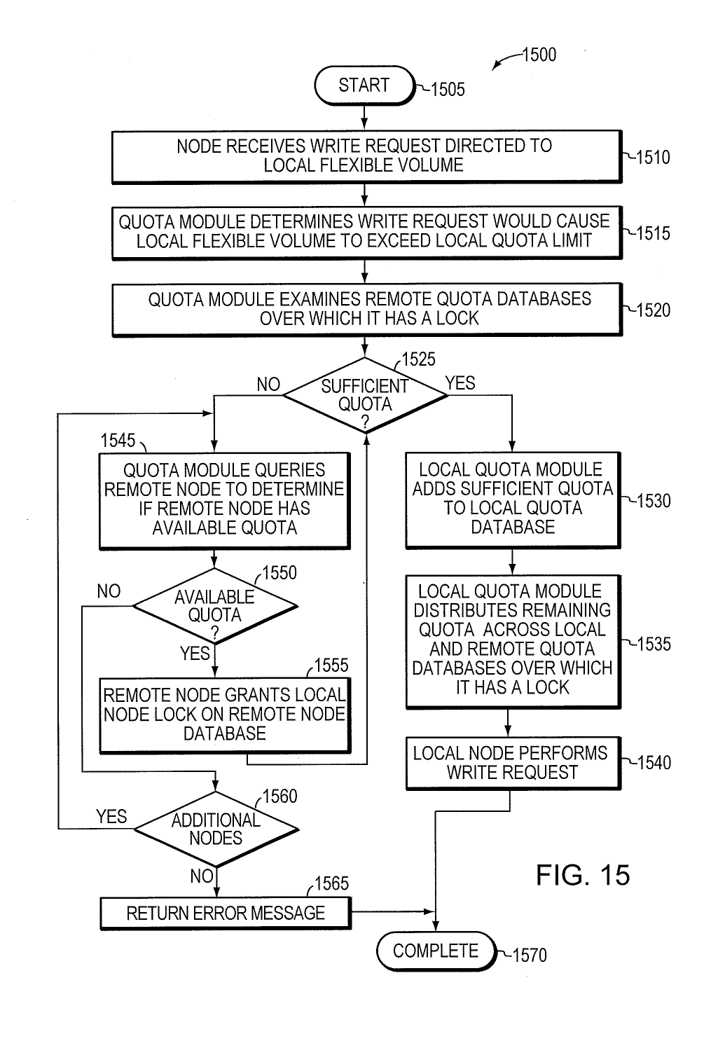

FIG. 15 is a flow chart detailing the steps of a procedure 1500 for reallocating quota among a plurality of flexible volumes. The procedure 1500 begins in step 1505 and continues to step 1510 where a node receives a write operation directed to a local flexible volume. This may be a write operation received from a client that is attempting to write data to the flexible volume stored or managed by the node. During processing of the write operation, the quota module of the local node determines that the write operation would cause the local flexible volume to exceed its local quota limit in step 1515. The quota module then examines one or more remote quota databases over which it has a lock in step 1520. This examination is made to determine whether the remote quota databases have sufficient quota to service the write operation in step 1525. Should there be sufficient quota, the local quota module then adds sufficient quota to its local quota database in step 1530. This may be accomplished by, for example, reducing the quota in one of the remote quota databases and adding the same amount to the local quota database. The local quota module then distributes the remaining quota across the local and remote quota databases over which it has a lock in step 1535. The local node may then perform the requested write operation step 1540. The procedure completes in step 1570.

However, if in step 1525 it is determined that insufficient quota exists, then the procedure 1500 branches to step 1545 where the local quota module queries a remote node to determine if the remote node has available quota. A determination is made in step 1550 whether sufficient quota is available on the queried remote node. If quota is available, then the procedure continues to step 1555 where the remote node grants to the local node a lock on the remote node's quota database. The procedure 1500 then continues to step 1525 and proceeds as described above. However, if available quota is not available in step 1550, the procedure 1500 branches to step 1560 where a determination is made whether other nodes are accessible. Should other nodes be accessible, then the procedure branches back to step 1545 where the local quota module queries another remote node to determine if the remote node has available quota. Should it be determined in step 1560 that additional nodes are not available, then the procedure 1500 continues to step 1565 where an error message is returned. The procedure 1500 then completes in step 1570.

In a further aspect of the disclosure, the nodes may be configured so that a single node, referred to as a repository node, maintains all free quota. When another node requires quota, that node requests the quota from the repository node. One advantage of such a system is that nodes do not need to query multiple nodes to identify a node with free quota.

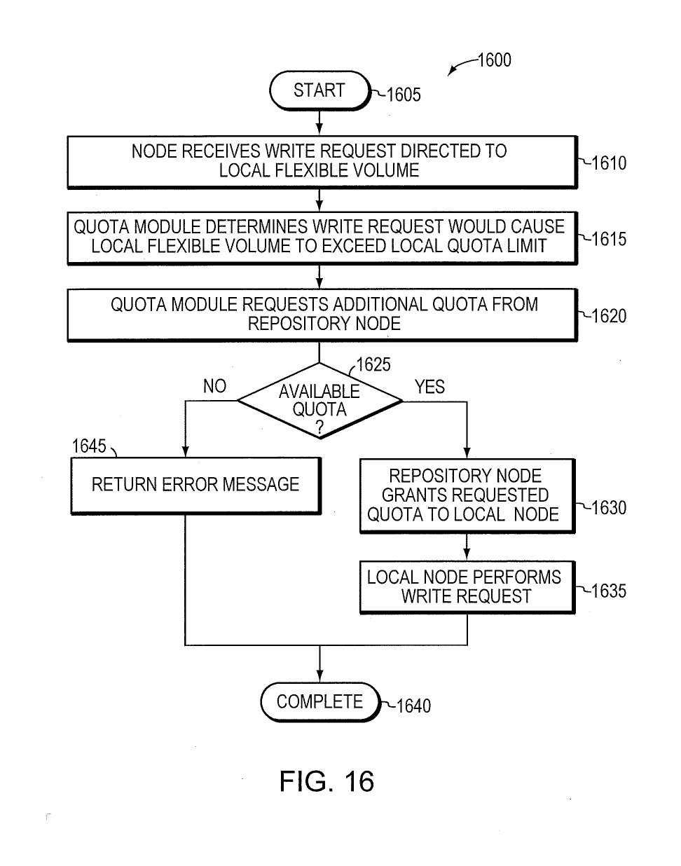

FIG. 16 is a flowchart detailing the steps of a procedure 1600 for reallocating quota among a plurality of flexible volumes. The procedure 1600 begins in step 1605 and continues to step 1610 where a node receives a write request directed to a local flexible volume. During processing of the write operation in step 1615, a quota module determines that the write request would cause the local flexible volume to exceed its local quota limit in step 1625. In response to determining that the write operation would cause the local flexible volume to exceed its local quota limit, the quota module requests additional quota from the repository node in step 1620. The repository node determines, in step 1625, whether available quota exists. If no available quota exists, the procedure branches to step 1645 where an error message is returned. The procedure then completes the step 1640.

However, if in step 1625 it is determined that available quota exists, then the procedure 1600 branches to step 1630 where the repository node grants the requested quota to the local node. The local node then performs the write operation in step 1635. The procedure 1610 completes in step 1640.

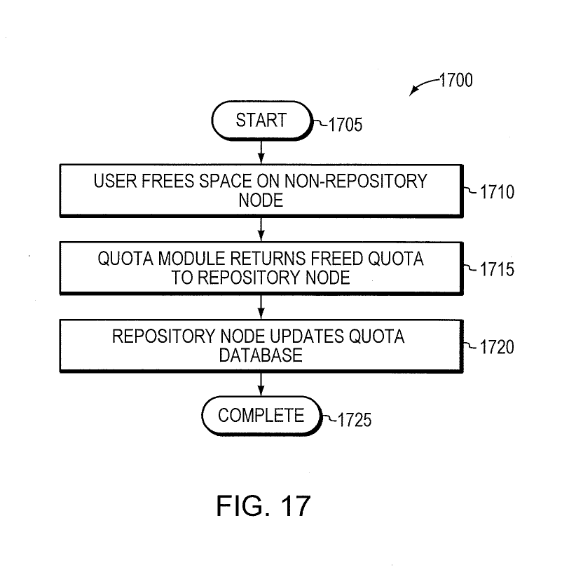

FIG. 17 is a flow chart detailing the steps of a procedure 1700 for returning freed quota to a repository node. The procedure 1700 begins in step 1705 and continues to step 1710 where a user frees space on a non-repository node. This may be accomplished by, for example, the user deleting a file or other data container. The quota module executing on the non-repository node detects the freed quota and returns the quota to the repository node in step 1715. The repository node then updates its quota database in step 1720 to reflect the freed quota. By updating its quota database, the repository node has tracked the quota so that it may re-allocate the quota to other nodes in response to requests, as described above in relation to FIG. 16. The procedure 1700 completes in step 1725.

The foregoing description has been directed to particular embodiments of this invention. It will be apparent, however, that other variations and modifications may be made to the described embodiments, with the attainment of some or all of their advantages. Specifically, it should be noted that the principles of the present invention may be implemented in non-distributed file systems. Furthermore, while this description has been written in terms of N and D-modules, the teachings of the present invention are equally suitable to systems where the functionality of the N and D-modules are implemented in a single system. Alternately, the functions of the N and D-nodes may be distributed among any number of separate systems, wherein each system performs one or more of the functions. Additionally, the procedures, processes and/or modules described herein may be implemented in hardware, software, embodied as a non-transitory computer-readable medium having program instructions, firmware, or a combination thereof. Therefore, it is the object of the appended claims to cover all such variations and modifications as come within the true spirit and scope of the invention.

What is claimed is:

1. A method comprising:
receiving, by a first node, a quota-consuming operation comprising a write operation, wherein the quota-consuming operation would cause the first node to exceed an assigned quota associated with a user;
querying, by the first node, a second node to determine when the second node has sufficient free quota associated with the user to service the received quota-consuming operation; and
redistributing, by the first node, an available quota evenly with the second node to perform the quota-consumption operation upon granting of a lock on a quota database associated with the second node when the second node is determined to have the sufficient free quota.

2. The method as set forth in claim 1 further comprising, performing, by the first node, an initial assignment of quota among a plurality of storage nodes organized to service the distributed file system, wherein the initial assignment of quota comprises assigning an equal amount of quota to each of the plurality of storage nodes.

3. The method as set forth in claim 1 wherein the quota redistribution further comprises reallocating, by the first node, one or more storage volumes and the quota database comprises data associated with distribution of the one or more storage volumes.

4. The method as set forth claim 1 further comprising querying, by the first node, a third node to determine when the third node has free quota.

5. The method as set forth in claim 1 further comprising, identifying, by the first node, an additional available quota in the third node upon deletion of a data file.

6. The method as set forth in claim 5 further comprising, redistributing, by the first node, the identified additional available quota to a quota database.

7. A non-transitory machine readable medium having stored thereon instructions for performing a method comprising machine executable code which when executed by at least one machine, causes the machine to:
receive a quota-consuming operation comprising a write operation, wherein the quota-consuming operation would cause the first node to exceed an assigned quota associated with a user;
query a second to determine when the second node has sufficient free quota associated with the user to service the received quota-consuming operation; and
redistribute an available quota evenly with the second node to perform the quota-consumption operation upon granting of a lock on a quota database associated with the second node when the second node is determined to have the sufficient free quota.

8. The medium as set forth in claim 7 further comprising, performing an initial assignment of quota among a plurality of storage nodes organized to service the distributed file system, wherein the initial assignment of quota comprises assigning an equal amount of quota to each of the plurality of storage nodes.

9. The medium as set forth in claim 7 wherein the quota redistribution further comprises reallocating one or more storage volumes and the quota database comprises data associated with distribution of the one or more storage volumes.

10. The medium as set forth in claim 7 further comprising querying a third node to determine when the third node has free quota.

11. The medium as set forth in claim 7 further comprising, identifying an additional available quota in the third node upon deletion of a data file.

12. The medium as set forth in claim 11 further comprising, redistributing the identified additional available quota to a quota database.

13. A first node comprising:
a memory containing machine readable medium comprising machine executable code having stored thereon instructions for performing a method of implementing quota system in a distributed file system:
a processor coupled to the memory, the processor configured to execute the machine executable code to cause the processor to:
receive a quota-consuming operation comprising a write operation, wherein the quota-consuming operation would cause the first storage node to exceed an assigned quota associated with a user;
query a second storage node to determine when the second storage node has sufficient free quota associated with the user to service the received quota-consuming operation; and
redistribute an available quota evenly with the second storage node to perform the quota-consumption operation upon granting of a lock on a quota database associated with the second storage node when the second storage node is determined to have the sufficient free quota.

14. The device as set forth in claim 13 wherein the processor is further configured to execute the machine executable code to perform an initial assignment of quota among a plurality of storage nodes organized to service the distributed file system, wherein the initial assignment of quota comprises assigning an equal amount of quota to each of the plurality of storage nodes.

15. The device as set forth in claim 13 wherein the processor is further configured to execute the machine executable code wherein the quota redistribution further comprises reallocating one or more storage volumes and the quota database comprises data associated with distribution of the one or more storage volumes.

16. The device as set forth in claim 13 wherein the processor is further configured to execute the machine executable code to query a third node to determine when the third node has free quota.

17. The device as set forth in claim 13 wherein the processor is further configured to execute the machine executable code to identify an additional available quota in the third node upon deletion of a data file.

18. The device as set forth in claim 17 wherein the processor is further configured to execute the machine executable code to redistribute the identified additional available quota to a quota database.
